(19) United States
(12) Patent Application Publication
(10) Pub. No.: US 2002/0099476 A1
(43) Pub. Date: Jul. 25, 2002

(54) Method and apparatus for indirect catalytic combustor preheating

(76) Inventors: Douglas A. Hamrin, Sherman Oaks, CA (US); Harry L. Jensen, Canoga Park, CA (US); Yungmo Kang, La Canada, CA (US); Mark Gilbreth, Woodland Hills, CA (US); Joel Wacknov, Westlake Village, CA (US); Simon Wall, Thousand Oaks, CA (US)

Correspondence Address: IRELL & MANELLA LLP, Suite 900, 1800 Avenue of the Stars, Los Angeles, CA, 90067, US

(21) Appl. No.: 09/977,883

(22) Filed: Oct. 11, 2001

Related U.S. Application Data
(63) Continuation-in-part of application No. 09/207,817, filed on Dec. 8, 1998.
(60) Provisional application No. 60/080,457, filed on Apr. 2, 1998.
(60) Provisional application No. 60/277,490, filed on Mar. 21, 2001.

(51) Int. Cl. F02C 7/26

(52) U.S. Cl. 700/287; 60/778

(57) ABSTRACT

A turbogenerator system including a recuperator and a catalytic combustor employs a preheater located between the turbine outlet and the recuperator low-pressure inlet to heat the low-pressure turbine exhaust. Heat from the turbine exhaust is transferred to a cool high-pressure flow in the recuperator. A recirculation loop employs valves downstream of the recuperator low-pressure outlet to divert the recuperator low-pressure exhaust into the compressor to be recirculated through the recuperator high-pressure side and the catalytic combustor. Reduced start-up times and emissions are achieved by raising the combustor catalyst to its light-off temperature in a shorter period of time.

### RELATED APPLICATIONS

This patent application is a continuation-in-part of utility patent application Ser. No. 09/207,817 filed on Dec. 8, 1998, which claims the priority of provisional application serial No. 60/080,457 filed on Apr. 2, 1998. This patent application also claims the priority of provisional patent application serial No. 60/277,490, filed Mar. 21, 2001.

### STATEMENT REGARDING FEDERALLY SPONSORED DEVELOPMENT

The U.S. Government has a paid-up license in this invention and the right in limited circumstances to require the patent owner to license others on reasonable terms as provided for by the terms of the Flex Energy Contract NO. 500-99-030ZDH-0-29047-03 awarded by the Department of Energy.

### BACKGROUND OF THE INVENTION

A turbogenerator electric power generation system is generally comprised of a compressor, a combustor including fuel injectors and an ignition source, a turbine, and an electrical generator. The combustor may be a catalytic combustor that utilize a catalyst to initiate and maintain an exothermic reaction with a fuel and air mixture. Catalytic combustors or reactors are only operational at temperatures above their particular catalyst light-off temperature, or the temperature under operating conditions at which the self sustaining catalytic reaction initiates. These conditions may include the fuel flow rate, fuel-to-air ratio, and pressure. During a cold start, fuel delivered to the catalytic combustor is not combusted completely until the catalyst has reached its light-off temperature, and therefore emissions may be high during a cold start. What is therefore needed is a method and apparatus for preheating a catalytic combustor to its light-off temperature quickly and efficiently.

### SUMMARY OF THE INVENTION

In one aspect, the present invention provides a method of starting a turbine engine having a compressor rotationally coupled to a turbine for compressing air, a recuperator for transferring heat from turbine exhaust to the compressed air, and a catalytic combustor to react fuel with the heated compressed air, the method comprising rotating the compressor to pass compressed air through the recuperator and the combustor and into the turbine, and heating the turbine exhaust flow. After exiting the recuperator, the turbine exhaust may be passed through the compressor to be compressed together with the air. The turbine exhaust may be heated by a heater fluidly disposed downstream of the turbine or by a heater coupled to the recuperator.

In another aspect, the present invention provides a turbine engine comprising a turbine, a compressor rotationally coupled to the turbine for compressing air, a recuperator fluidly coupled to the compressor and to the turbine for transferring heat from turbine exhaust to the compressed air, a catalytic combustor fluidly coupled to the turbine and to the recuperator for reacting fuel with the heated compressed air, and a heater fluidly coupled to the turbine outlet for heating the turbine exhaust flow.

In a further aspect, the present invention provides a generator system comprising a turbine, a compressor rotationally coupled to the turbine for rotating therewith to compress air, a recuperator fluidly coupled to the compressor and to the turbine for transferring heat from turbine exhaust to the compressed air, a catalytic combustor fluidly coupled to the turbine and to the recuperator for reacting fuel with the heated compressed air, a heater fluidly coupled to the turbine outlet for heating the turbine exhaust flow, a motor/generator rotationally coupled to the turbine for rotating therewith to produce power, a DC output bus for providing the power to a load; and a bi-directional motor/generator power converter connected between the motor/generator and the DC bus to automatically control system speed by varying the flow of power, after system startup, from the motor/generator to the DC bus and from the DC bus to the motor/generator.

### BRIEF DESCRIPTION OF THE DRAWINGS

FIG. 1 is perspective view, partially in section, of a turbogenerator system according to the present invention;

FIG. 2 is a functional diagram of the turbogenerator system of FIG. 1 including turbine exhaust recirculation and a preheater according to the invention;

FIG. 3 is a functional diagram of the turbogenerator system of FIG. 1 including turbine exhaust recirculation and a recuperator electric heater according to the invention; and

FIG. 4 is a functional diagram showing the turbogenerator of FIG. 1 and an associated power controller.

### DETAILED DESCRIPTION OF THE INVENTION

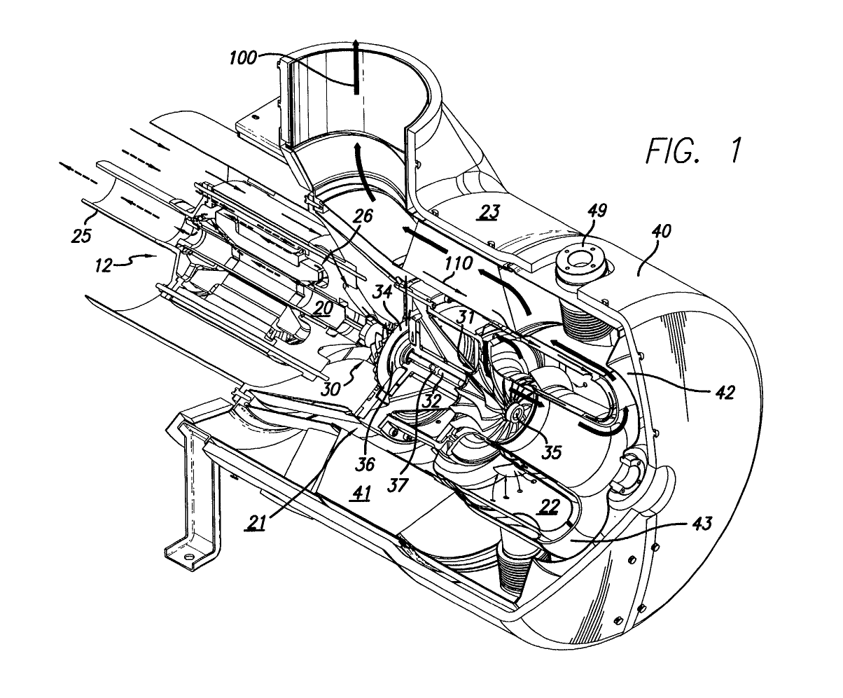

Referring to FIG. 1, integrated turbogenerator system 12 generally includes motor/generator 20, power head 21, combustor 22, and recuperator (or heat exchanger) 23. Power head 21 of turbogenerator 12 includes compressor 30, turbine 31, and common shaft 32. Tie rod 33 to magnetic rotor 26 (which may be a permanent magnet) of motor/generator 20 passes through bearing rotor 32. Compressor 30 includes compressor impeller or wheel 34 that draws air flowing from an annular air flow passage in outer cylindrical sleeve 29 around stator 27 of the motor/generator 20. Turbine 31 includes turbine wheel 35 that receives hot exhaust gas flowing from combustor 22. Combustor 22 receives preheated air from recuperator 23 and fuel through a plurality of fuel injector guides 49. Compressor wheel 34 and turbine wheel 35 are supported on common shaft or rotor 32 having radially extending air-flow bearing rotor thrust disk 36. Common shaft 32 is rotatably supported by a single air-flow journal bearing within center bearing housing 37 while bearing rotor thrust disk 36 at the compressor end of common shaft 32 is rotatably supported by a bilateral air-flow thrust bearing.

Motor/generator 20 includes magnetic rotor or sleeve 26 rotatably supported within generator stator 27 by a pair of spaced journal bearings. Both rotor 26 and stator 27 may include permanent magnets. Air is drawn by the rotation of rotor 26 and travels between rotor 26 and stator 27 and further through an annular space formed radially outward of the stator to cool generator 20. Inner sleeve 25 serves to separate the air expelled by rotor 26 from the air being drawn in by compressor 30, thereby preventing preheated air from being drawn in by the compressor and adversely affecting the performance of the compressor (due to the lower density of preheated air as opposed to ambient-temperature air).

In operation, air is drawn through sleeve 29 by compressor 30, compressed, and directed to flow into recuperator 23. Recuperator 23 includes annular housing 40 with heat transfer section or core 41, exhaust gas dome 42, and combustor dome 43. Heat from exhaust gas 110 exiting turbine 31 is used to preheat compressed air 100 flowing through recuperator 23 before it enters combustor 22, where the preheated air is mixed with fuel and ignited such as by electrical spark, hot surface ignition, or catalyst. The fuel may also be premixed with all or a portion of the preheated air prior to injection into the combustor. The resulting combustion gas expands in turbine 31 to drive turbine impeller 35 and, through common shaft 32, drive compressor 30 and rotor 26 of generator 20. The expanded turbine exhaust gas then exits turbine 31 and flows through recuperator 23 before being discharged from turbogenerator 12.

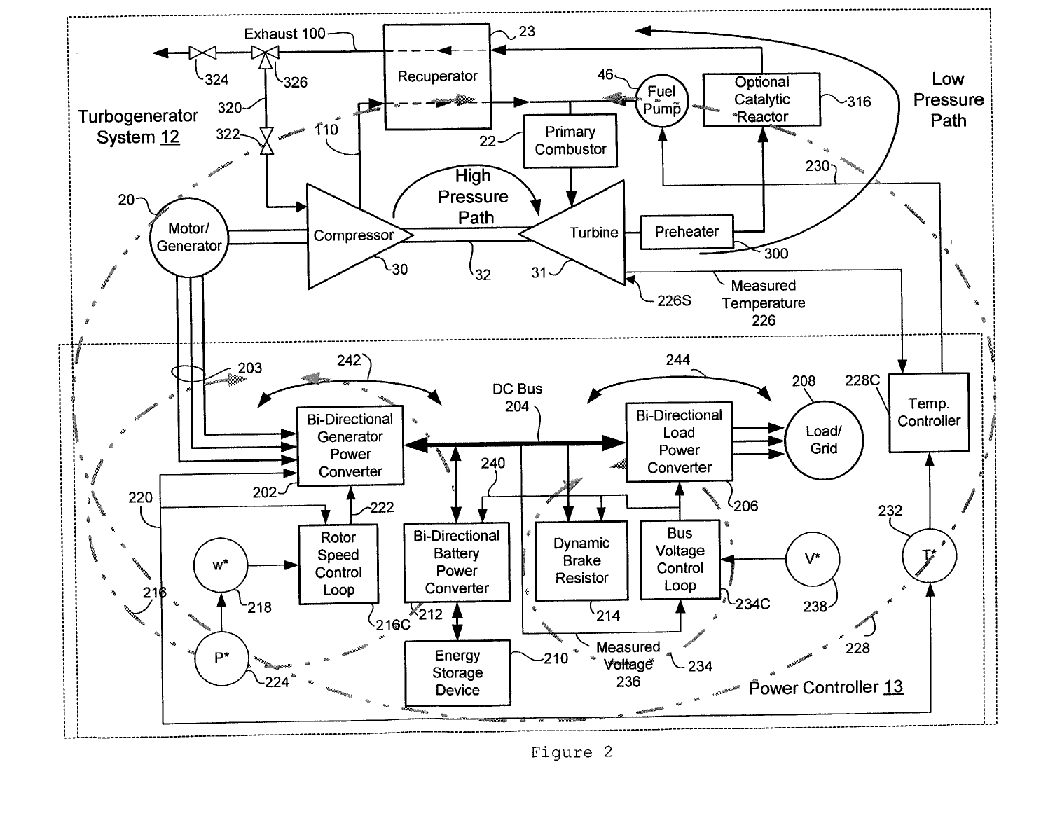

Referring now to FIG. 2, integrated turbogenerator system 12 includes power controller 13 with three substantially decoupled control loops for controlling (1) rotary speed, (2) temperature, and (3) DC bus voltage. A more detailed description of an appropriate power controller is disclosed in the parent application, co-pending U.S. patent application Ser. No. 09/207,817, filed Dec. 8, 1998 in the names of co-inventors Gilbreth, Wacknov and Wall, assigned to the assignee of the present application, and incorporated herein in its entirety by reference.

Temperature control loop 228 regulates a temperature related to the desired operating temperature of primary combustor 22 to a set point by varying fuel flow from fuel pump 46 to primary combustor 22. Temperature controller 228C receives a temperature set point T* from temperature set point source 232 and receives a measured temperature from temperature sensor 226S via measured temperature line 226. Temperature controller 228C generates and transmits a fuel control signal to fuel pump 50P over fuel control signal line 230 for controlling the amount of fuel supplied by fuel pump 46 to primary combustor 22 to an amount intended to result in a desired operating temperature in primary combustor 22. Temperature sensor 226S may directly measure the temperature in primary combustor 22 or may measure a temperature of an element or area from which the temperature in the primary combustor 22 may be inferred.

Speed control loop 216 controls the speed of common shaft 32 by varying the torque applied by motor generator 20 to the common shaft. Torque applied by the motor generator to the common shaft depends upon power or current drawn from or pumped into windings of motor/generator 20. Bi-directional generator power converter 202 is controlled by rotor speed controller 216C to transmit power or current in or out of motor/generator 20, as indicated by bi-directional arrow 242. A sensor in turbogenerator 12 senses the rotary speed of common shaft 32, such as by measuring the frequency of motor/generator 20 power output and determining the speed based upon this measured frequency, and transmits a rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling the transfer of power or current between AC lines 203 (i.e., from motor/generator 20) and DC bus 204 by generator power converter 202. Rotary speed set point source 218 may convert a power set point P* received from power set point source 224 to the rotary speed set point.

Voltage control loop 234 controls bus voltage on DC bus 204 to a set point by transferring power or voltage between DC bus 204 and any of (1) load/grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236 to bus voltage controller 234C, which further receives a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 13 regulates temperature to a set point by varying fuel flow, controls shaft speed to a set point (indicated by bi-directional arrow 242) by adding or removing power or current to/from motor/generator 20 under control of generator power converter 202, and controls DC bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

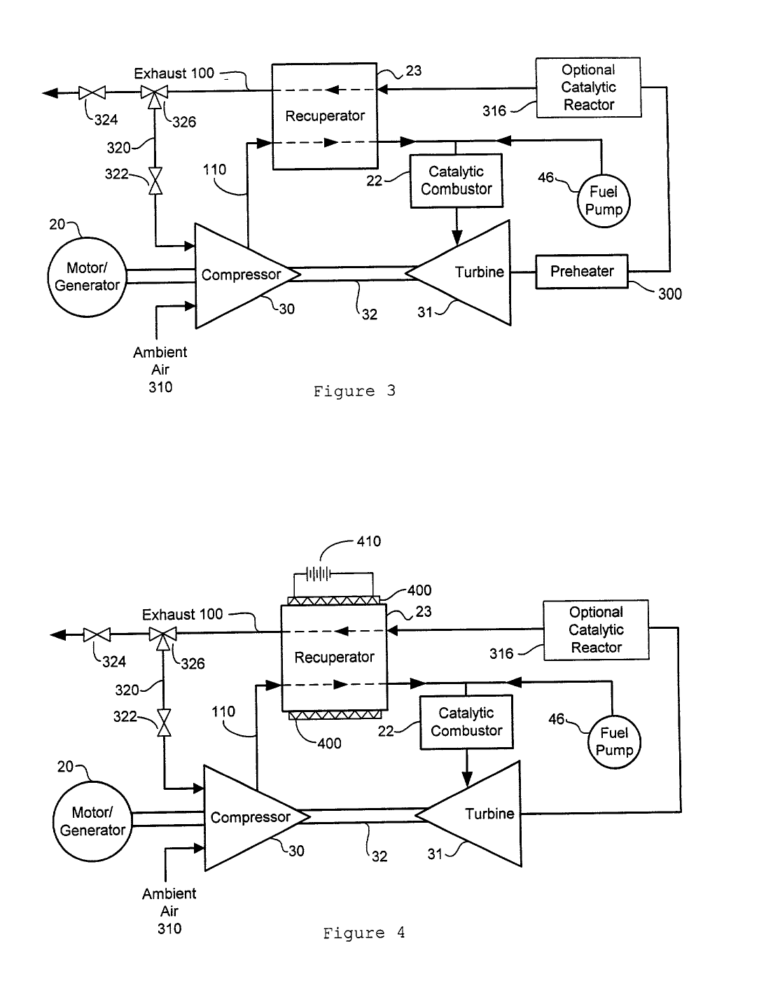

Referring to FIG. 3, combustor 22 is a catalytic combustor and preheater 300 is provided downstream of turbine 31 to heat exhaust gas stream 100 leaving the turbine and entering the low-pressure side of recuperator 23. Preheater 300 may be a flame heater fueled by gaseous or liquid fuel, or it may be an electric heater. The electric heater may be powered by a separate power source (not shown) such as the power source used to initially start the system (e.g. a battery or a power grid), or it may receive power from motor/generator 20 once the turbogenerator system reaches operating speed.

The engine of the invention provides heat to catalytic combustor 22 indirectly, that is, by directly heating the gas flowing through the low-pressure side of recuperator 23 and utilizing the heat-transfer properties of the recuperator to transfer the heat from heated low-pressure gas stream 100 to cool, compressed air stream 110 prior to the compressed air reaching the combustor. Thus, in a typical method of operation, during a cold start turbine 31 and compressor 30 are rotated through common shaft 32 by motor/generator 20, which is provided with electric power (not shown) to operate as a motor. As the compressor begins to turn, it begins to compress ambient air 310 and pass it as compressed air 110 through recuperator 23 before it enters catalytic combustor 22 together with fuel from fuel pump 46. Because the catalyst in the combustor is initially below its light-off temperature, the air-fuel mixture passes through the combustor and enters the turbine 31 in an non-combusted state, from where it is exhausted to the preheater 300. In the preheater, the air-fuel mixture is heated by the heat generated by the preheater or, in an alternative embodiment, is combusted in the preheater, and then proceeds to flow through the low-pressure side of the recuperator where it transfers a significant portion of its heat energy to counter-flowing cool, compressed air 110. As heated compressed air 110 flows out of recuperator 23 and into catalytic combustor 22, it begins to heat the catalyst in the combustor and eventually raises the temperature of the catalyst to its light-off temperature, at which point the air-fuel mixture commences reacting with the catalyst in an exothermic reaction that produces hot exhaust gas. As the hot exhaust gas expands in turbine 31, it drives the turbine and compressor via common shaft 32 and the turbogenerator system achieves self-sustaining operation. At this point the source of power is disconnected from motor/generator 20, and the motor/generator can be reconfigured to operate as an electric power generator driven by common shaft 32.

In an alternative embodiment of The engine of the invention, the start-up sequence described previously may be modified to keep fuel pump 46 shut-off until the catalyst reaches its light-off temperature. In this manner no unburned fuel is exhausted to the atmosphere, thereby providing an environmentally cleaner start-up method. This start-up method also does not require that preheater 300 be able to combust the fuel provided by fuel pump 46, and thus a simpler, less costly preheater may be used to implement this alternative embodiment. Fuel pump 46 could thus be controlled by a temperature sensor (not shown) monitoring the turbine exhaust temperature (TET). Once the catalyst reaches its light-off temperature, the TET will also reach a predetermined value (derived empirically or by any other practicable methods) at which point the fuel pump will be turned on to begin providing fuel to the combustor to initiate and sustain the exothermic reaction.

With continued reference to FIG. 3, in another embodiment of the invention, exhaust diversion line 320 is provided from the low-pressure exit side of recuperator 23 to the inlet of compressor 30. Valve 322 is provided on diversion line 320 and valve 324 is provided on the low-pressure line downstream of the diversion line to throttle the recuperator exhaust. Alternatively, instead of valves 322 and 324, three-way valve 326 may be provided at the juncture of the diversion line 320. During a cold start exhaust throttle valve 324 is shut off and exhaust diversion valve 322 is opened to divert low-pressure exhaust stream 100 into compressor 30 and thus recirculate the exhaust through the recuperator high-pressure side and into combustor 22. If three-way valve 326 is provided, the three-way valve is actuated to divert exhaust stream 100 into compressor 30 as described above. By recirculating low-pressure exhaust stream 100 in this manner, substantially all of the heat energy input by preheater 300 is recirculated through the system and eventually transferred to the catalyst in combustor 22. This method thus provides significantly quicker cold start times and further reduces emissions as well as startup power requirements. This may be advantageous for stand-alone applications where turbogenerator system 12 is located at a remote site with no access to a power grid and where it must thus rely solely on battery power to start up.

Still referring to FIG. 3, optional secondary catalytic reactor 316 may be installed downstream of turbine 31 to combust any unburned fuel present in low-pressure exhaust flow stream 100 exiting the turbine. Secondary catalytic reactor 316 may thus further reduce emissions of turbogenerator system 12, as well as increase the overall efficiency of the system by generating additional heat from the otherwise-unburned fuel. Secondary reactor 316 is shown located downstream of preheater 300, where it is heated directly by the preheater. Alternatively, secondary reactor 316 may be located upstream of preheater 300 and downstream of turbine 31. In this configuration, main combustor 22 will accumulate most of the heat supplied by the preheater and reach its light-off temperature before the secondary reactor. However, this configuration will also entail passing hot exhaust gas 100 from the secondary reactor through the preheater during normal, steady state operations, thereby requiring that the preheater be able to withstand the temperatures that may be generated within the secondary reactor. Further details for a system including a secondary catalytic reactor may be found in co-pending U.S. application Ser. No. 09/933,633 filed on Aug. 22, 2001, assigned to the assignee of the present application, and incorporated herein in its entirety by reference thereto.

Referring to FIG. 4, electric band heater 400 is mounted onto recuperator 23 to heat all gaseous flows through the recuperator. Electric heater 400 receives power from power source 410 that may be the same as the start-up power source (e.g. a battery, or a power grid). Heater 400 heats the recuperator uniformly, and thus both high pressure air stream 110 entering combustor 22 as well as low-pressure exhaust gas stream 100 exiting to the atmosphere are heated in this alternative configuration. By use of an exhaust recirculation loop as described above, wherein diversion valve 322 (or three-way valve 326) diverts the exhaust exiting the recuperator low-pressure side through the recuperator high-pressure side and the combustor, substantially all of the heat input by electric heater 400 will be circulated through the combustor and eventually transferred to the catalyst. Although recirculating the exhaust is not necessary when using the electric heater, the over-all start-up time may be substantially quicker and the amount of start-up power required lower by using exhaust recirculation in combination with the electric heater.

Still referring to FIG. 4, this embodiment may also incorporate optional secondary catalytic reactor 316, located between the exhaust of turbine 31 exhaust and the low-pressure inlet of recuperator 23. Most of the heat generated by electric heater 400 will be deposited in primary combustor 22, and secondary reactor 316 may not reach light-off temperature until turbogenerator system 12 has reached self-sustaining operation.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention, as defined and limited solely by the following claims.

What is claimed is:

1. A method of starting a turbine engine having a compressor rotationally coupled to a turbine for compressing air, a recuperator for transferring heat from turbine exhaust to the compressed air, and a catalytic combustor to react fuel with the heated compressed air, the method comprising:
rotating the compressor to pass compressed air through the recuperator and the combustor and into the turbine; and
heating the turbine exhaust flow.

2. The method of claim 1, wherein the turbine engine comprises a heater fluidly disposed downstream of the turbine to heat the turbine exhaust.

3. The method of claim 1, wherein heating the turbine exhaust flow comprises:
discontinuing to heat the turbine exhaust flow when the combustor catalyst has reached its light-off temperature.

4. The method of claim 3, comprising:
monitoring the turbine exhaust temperature to determine when the combustor catalyst has reached its light-off temperature.

5. The method of claim 3, wherein heating the turbine exhaust flow comprises:
discontinuing to heat the turbine exhaust flow when the turbine exhaust temperature has reached a predetermined value.

6. The method of claim 1, wherein heating the turbine exhaust flow comprises:
heating the turbine exhaust flow prior to the exhaust flow entering the recuperator.

7. The method of claim 6, wherein the turbine engine comprises a heater fluidly disposed between the turbine outlet and the recuperator to heat the turbine exhaust.

8. The method of claim 1, wherein heating the turbine exhaust flow comprises:
heating the recuperator.

9. The method of claim 8, wherein the turbine engine comprises a heater coupled to the recuperator to heat the recuperator.

10. The method of claim 9, wherein the heater is an electric band heater.

11. The method of claim 8, wherein heating the recuperator comprises:
discontinuing to heat the turbine exhaust flow when the combustor catalyst has reached its light-off temperature.

12. The method of claim 11, comprising:
monitoring the turbine exhaust temperature to determine when the combustor catalyst has reached its light-off temperature.

13. The method of claim 11, comprising:
discontinuing to heat the turbine exhaust flow when the turbine exhaust temperature has reached a predetermined value.

14. The method of claim 1, further comprising:
passing the turbine exhaust exiting from the recuperator through the compressor to be compressed together with air.

15. The method of claim 14, wherein passing the turbine exhaust exiting from the recuperator through the compressor comprises:
discontinuing to pass the turbine exhaust exiting from the recuperator through the compressor when the combustor catalyst reaches its light-off temperature.

16. The method of claim 15, comprising:
monitoring the turbine exhaust temperature to determine when the combustor catalyst has reached its light-off temperature.

17. The method of claim 15, wherein passing the turbine exhaust exiting from the recuperator through the compressor comprises:
discontinuing to pass the turbine exhaust exiting from the recuperator through the compressor when the turbine exhaust temperature has reached a predetermined value.

18. The method of claim 15, wherein heating the turbine exhaust flow comprises:
discontinuing to heat the turbine exhaust flow when the combustor catalyst has reached its light-off temperature.

19. The method of claim 1, wherein heating the turbine exhaust flow comprises:
heating the turbine exhaust flow to transfer heat through the recuperator to the compressed air prior to the compressed air entering the combustor.

20. The method of claim 19, wherein heating the turbine exhaust flow comprises:
heating the turbine exhaust flow to transfer heat through the recuperator to the compressed air prior to the compressed air entering the combustor for the heated compressed air to heat the catalyst in the combustor.

21. The method of claim 20, wherein heating the turbine exhaust flow comprises:
discontinuing to heat the turbine exhaust flow when the combustor catalyst has reached its light-off temperature.

22. The method of claim 21, comprising:
monitoring the turbine exhaust temperature to determine when the combustor catalyst has reached its light-off temperature.

23. The method of claim 21, wherein heating the turbine exhaust flow comprises:
discontinuing to heat the turbine exhaust flow when the turbine exhaust temperature has reached a predetermined value.

24. The method of claim 21, further comprising:
discontinuing to pass the turbine exhaust exiting from the recuperator through the compressor to be compressed together with air when the combustor catalyst has reached its light-off temperature.

25. The method of claim 24, comprising:
monitoring the turbine exhaust temperature to determine when the combustor catalyst has reached its light-off temperature.

26. The method of claim 24, wherein passing the turbine exhaust exiting from the recuperator through the compressor comprises:
discontinuing to pass the turbine exhaust exiting from the recuperator through the compressor when the turbine exhaust temperature has reached a predetermined value.

27. The method of claim 1, comprising:
providing fuel to the combustor when the catalyst has reached its light-off temperature.

28. The method of claim 27, comprising:
monitoring the turbine exhaust temperature to determine when the combustor catalyst has reached its light-off temperature.

29. The method of claim 27, comprising:
providing fuel to the combustor when the turbine exhaust temperature has reached a predetermined value.

30. The method of claim 1, comprising:
providing fuel to the combustor together with the compressed air.

31. The method of claim 30, wherein heating the turbine exhaust flow comprises:
combusting fuel in the turbine exhaust flow.

32. The method of claim 31, wherein the turbine engine comprises a heater fluidly disposed downstream of the turbine to combust fuel in the turbine exhaust.

33. A turbine engine, comprising:
a turbine;
a compressor rotationally coupled to the turbine for compressing air;
a recuperator fluidly coupled to the compressor and to the turbine for transferring heat from turbine exhaust to the compressed air;
a catalytic combustor fluidly coupled to the turbine and to the recuperator for reacting fuel with the heated compressed air; and
a heater fluidly coupled to the turbine outlet for heating the turbine exhaust flow.

34. The engine of claim 33, wherein the heater comprises:
a heater for heating the turbine exhaust flow until the combustor catalyst has reached its light-off temperature.

35. The engine of claim 34, comprising:
a controller connected to the engine for monitoring the turbine exhaust temperature to determine when the combustor catalyst has reached its light-off temperature.

36. The engine of claim 34, wherein the heater comprises:
a heater for heating the turbine exhaust flow until the turbine exhaust temperature has reached a predetermined value.

37. The engine of claim 33, wherein the heater is fluidly disposed downstream of the turbine and upstream of the recuperator exhaust side.

41. The engine of claim 33, wherein the heater is coupled to the recuperator to heat the recuperator.

42. The engine of claim 41, wherein the heater comprises:
a heater for heating the recuperator until the combustor catalyst has reached its light-off temperature.

43. The engine of claim 42, comprising:
a controller connected to the engine for monitoring the turbine exhaust temperature to determine when the combustor catalyst has reached its light-off temperature.

44. The engine of claim 42, wherein the heater comprises:
a heater for heating the recuperator until the turbine exhaust temperature has reached a predetermined value.

45. The engine of claim 41, wherein the heater is an electric band heater.

46. The engine of claim 33, comprising:
a passage disposed fluidly between the outlet of the recuperator exhaust side and the compressor inlet for passing the turbine exhaust exiting from the recuperator through the compressor to be compressed together with air.

47. The engine of claim 46, comprising:
a controller connected to the engine for controlling the passage to pass the turbine exhaust exiting from the recuperator through the compressor until the combustor catalyst reaches its light-off temperature.

48. The engine of claim 47, wherein the controller comprises:
a controller connected to the engine for monitoring the turbine exhaust temperature to determine when the combustor catalyst has reached its light-off temperature.

49. The engine of claim 47, wherein the controller comprises:
a controller connected to the engine for controlling the passage to pass the turbine exhaust exiting from the recuperator through the compressor until the turbine exhaust temperature has reached a predetermined value.

50. The engine of claim 47, wherein the heater comprises:
a heater for heating the turbine exhaust flow until the combustor catalyst has reached its light-off temperature.

51. The engine of claim 33, wherein the heater comprises:
a heater for heating the turbine exhaust flow to transfer heat through the recuperator to the compressed air prior to the compressed air entering the combustor.

52. The engine of claim 51, wherein the heater comprises:
a heater for heating the turbine exhaust flow to transfer heat through the recuperator to the compressed air prior to the compressed air entering the combustor for the heated compressed air to heat the catalyst in the combustor.

53. The engine of claim 52, wherein the heater comprises:
a heater for heating the turbine exhaust flow until the combustor catalyst has reached its light-off temperature.

54. The engine of claim 53, comprising:
a controller connected to the engine for monitoring the turbine exhaust temperature to determine when the combustor catalyst has reached its light-off temperature.

55. The engine of claim 53, wherein the heater comprises:
a heater for heating the turbine exhaust flow until the turbine exhaust temperature has reached a predetermined value.

56. The engine of claim 52, comprising:
a passage disposed fluidly between the outlet of the recuperator exhaust side and the compressor inlet for passing the turbine exhaust exiting from the recuperator through the compressor to be compressed together with air until the combustor catalyst has reached its light-off temperature.

57. The engine of claim 56, comprising:
a controller connected to the engine for monitoring the turbine exhaust temperature to determine when the combustor catalyst has reached its light-off temperature.

58. The engine of claim 56, wherein the heater comprises:
a heater for passing the turbine exhaust exiting from the recuperator through the compressor until the turbine exhaust temperature has reached a predetermined value.

59. The engine of claim 33, comprising:
a fuel pump fluidly connected to the combustor for providing fuel to the combustor when the catalyst has reached its light-off temperature.

60. The engine of claim 59, comprising:
a controller connected to the engine for monitoring the turbine exhaust temperature to determine when the combustor catalyst has reached its light-off temperature.

61. The engine of claim 59, comprising:
a fuel pump fluidly connected to the combustor for providing fuel to the combustor when the turbine exhaust temperature has reached a predetermined value.

62. The engine of claim 33, comprising:
a fuel pump fluidly connected to the combustor for providing fuel to the combustor together with the compressed air.

63. The engine of claim 62, wherein the heater comprises:
a heater for combusting fuel in the turbine exhaust flow.

64. A turbogenerator system, comprising:
a turbine;
a compressor rotationally coupled to the turbine for rotating therewith to compress air;
a recuperator fluidly coupled to the compressor and to the turbine for transferring heat from turbine exhaust to the compressed air;
a catalytic combustor fluidly coupled to the turbine and to the recuperator for reacting fuel with the heated compressed air;
a heater fluidly coupled to the turbine outlet for heating the turbine exhaust flow;
a motor/generator rotationally coupled to the turbine for rotating therewith to produce power;
a DC output bus for providing the power to a load; and
a bi-directional motor/generator power converter connected between the motor/generator and the DC bus to automatically control system speed by varying the flow of power, after system startup, from the motor/generator to the DC bus and from the DC bus to the motor/generator.

65. The system of claim 64, wherein the motor/generator comprises:
a motor/generator connected between the turbine and the motor/generator power converter for transferring power from the turbine to the motor/generator power converter to reduce system speed, and for transferring power from the motor/generator power converter to the turbine to increase system speed.

66. The system of claim 65, comprising:
a fuel control system connected to the combustor for automatically controlling turbine temperature by varying a flow of fuel to the combustor.

67. The system of claim 66, wherein the fuel control system comprises:
a fuel control system connected to the combustor for automatically controlling the turbine temperature to a temperature selected in accordance with the system speed to which the system is being controlled.

68. The system of claim 67, comprising:
a bi-directional output power converter connected between said DC bus and the load for automatically controlling a DC bus voltage by varying the power applied from the DC bus to the load and from the load to the DC bus.

69. The system of claim 68, comprising:
a power controller operating the motor/generator power converter, the output power converter, and the fuel control system to automatically control turbine temperature, system speed, and a DC bus voltage.

70. A turbogenerator system, comprising:
a turbine;
a compressor rotationally coupled to the turbine for rotating therewith to compress air;
a recuperator fluidly coupled to the compressor and to the turbine for transferring heat from turbine exhaust to the compressed air;
a catalytic combustor fluidly coupled to the turbine and to the recuperator for reacting fuel with the heated compressed air;
a heater fluidly coupled to the turbine outlet for heating the turbine exhaust flow;
a passage disposed fluidly between the outlet of the recuperator exhaust side and the compressor inlet for passing the turbine exhaust exiting from the recuperator through the compressor to be compressed together with air;
a motor/generator rotationally coupled to the turbine for rotating therewith to produce power;
a DC output bus for providing the power to a load; and
a bi-directional motor/generator power converter connected between the motor/generator and the DC bus to automatically control system speed by varying the flow of power, after system startup, from the motor/generator to the DC bus and from the DC bus to the motor/generator.

71. The system of claim 70, wherein the motor/generator comprises:
a motor/generator connected between the turbine and the motor/generator power converter for transferring power from the turbine to the motor/generator power converter to reduce system speed, and for transferring power from the motor/generator power converter to the turbine to increase system speed.

72. The system of claim 71, comprising:
a fuel control system connected to the combustor for automatically controlling turbine temperature by varying a flow of fuel to the combustor.

73. The system of claim 72, wherein the fuel control system comprises:
a fuel control system connected to the combustor for automatically controlling the turbine temperature to a temperature selected in accordance with the system speed to which the system is being controlled.

74. The system of claim 73, comprising:
a bi-directional output power converter connected between said DC bus and the load for automatically controlling a DC bus voltage by varying the power applied from the DC bus to the load and from the load to the DC bus.

75. The system of claim 74, comprising:
a power controller operating the motor/generator power converter, the output power converter, and the fuel control system to automatically control turbine temperature, system speed, and a DC bus voltage.
